(19) United States
(12) Patent Application Publication
(10) Pub. No.: US 2020/0209053 A1
(43) Pub. Date: Jul. 2, 2020

(54) MOTOR VIBRATION OR NOISE FREQUENCY DETECTING APPARATUS AND METHOD THEREOF

(71) Applicant: Industrial Technology Research Institute, Hsinchu (TW)

(72) Inventor: Chao-Jen Huang, Hsinchu County (TW)

(73) Assignee: Industrial Technology Research Institute, Hsinchu (TW)

(21) Appl. No.: 16/234,585

(22) Filed: Dec. 28, 2018

(51) Int. Cl. G01H 1/00; H02K 11/35

(52) U.S. Cl. CPC G01H 1/003; H02K 11/35

(57) ABSTRACT

The disclosure discloses a motor vibration or noise frequency detecting apparatus and method thereof. A processor and a frequency sensing unit are used to process and quantify a time domain signal, obtain a frequency domain result through computation, obtain a characteristic amplitude from the frequency domain result, and set characteristic amplitude as a trigger amplitude, which is then compared with a to-be-measured amplitude for use in computations or triggering events. The disclosure is used in a motor apparatus to detect a time domain abnormality, save power consumption for long-term use of frequency domain detection, and allow the motor to be monitored for a long time under battery power so the loss of the production line caused by the unwarranted shutdown can be avoided.

### TECHNICAL FIELD

The disclosure relates to a motor failure detecting method and an apparatus thereof, and more particularly, to a motor vibration or noise frequency detecting apparatus and a method thereof.

### BACKGROUND

A motor, an electromotor or an electric motor is an electrical device that can convert electrical energy into mechanical energy and use the mechanical energy to generate kinetic energy for driving electrical equipment of other devices.

Common motor failure detecting methods may include: a multi-sensor detecting method, a vibration sensing method, a noise sensing method and the like.

In the multi-sensor detecting method, vibration, noise and temperature of the motor are sensed by a plurality of sensors so a failure condition of the motor can then be predicted by the sensed vibration, noise and temperature. In the vibration sensing method, a vibration signal of the motor is obtained and a spectrum analysis is performed on the vibration signal of the sensor to obtain a spectrum characteristic, so a fault type of the motor can then be determined by interpreting the spectrum characteristic. In the noise sensing method, a noise signal of the motor is obtained, and a spectrum of the noise signal is analyzed to obtain a spectrum characteristic, so a fault type of the motor can then be determined by interpreting the spectrum characteristic.

Each of the various motor failure detecting methods described above is used to continuously perform a failure detection for the motor 24 hours a day. Although these methods can be used to detect the motor failure, if the battery is used as the power source to continuously perform the failure detection, the battery life will be quickly exhausted since a calculation power is considerably high. Therefore, the present disclosure aims to utilize a simple time-domain sensing method for the motor to determine the motor failure, and utilize a complete failure detecting method to achieve a research and development goal for improving conventional detecting technology and improving battery life.

### SUMMARY

In order to improve the motor failure detecting methods in the conventional art and overcome the issue of large power consumption in computations, the disclosure proposes a motor vibration or noise frequency detecting apparatus, which includes: a processor; and a frequency sensing unit, electrically connected to the processor. The processor quantifies a time domain signal captured from the frequency sensing unit by a sampling rate (a step S1); computes a frequency domain result from the quantified time domain signal (a step S2); sets a characteristic frequency according to the frequency domain result, and sets a target sampling rate to a frequency at least twice the characteristic frequency (a step S3); takes a signal maximum value in starting N periods of the time domain signal as a sampling start point (a step S4), where N is at least one period; samples the time domain signal according to the sampling start point and the target sampling rate, calculates a characteristic amplitude, and sets a trigger amplitude according to the characteristic amplitude (a step S5); waits for a set delay time (a step S6); quantifies a to-be-measured time domain signal by the sampling rate, and takes a signal maximum value in starting N periods of the to-be-measured time domain signal as a to-be-measured sampling start point (a step S7), where N is at least one period; samples the to-be-measured time domain signal according to the to-be-measured sampling start point and the target sampling rate, and calculates a to-be-measured amplitude (a step S8); and determines whether the to-be-measured time domain signal is lower than a size of the trigger amplitude, and if yes, proceeds to execute the step S1 or trigger an event, if no, proceeds to execute the step S6 (a step S9).

The disclosure also proposes a motor vibration or noise frequency detecting method, which includes: a step S1, quantifying a time domain signal by a sampling rate; a step S2, computing a frequency domain result from the quantified time domain signal; a step S3, setting a characteristic frequency according to the frequency domain result, and setting a target sampling rate to a frequency at least twice the characteristic frequency; a step S4, taking a signal maximum value in starting N periods of the time domain signal as a sampling start point, where N is at least one period; a step S5, sampling the time domain signal according to the sampling start point and the target sampling rate, calculating a characteristic amplitude, and setting a trigger amplitude according to the characteristic amplitude; a step S6, waiting for a set delay time; a step S7, quantifying a to-be-measured time domain signal by the sampling rate, and taking a signal maximum value in starting N periods of the to-be-measured time domain signal as a to-be-measured sampling start point, where N is at least one period; a step S8, sampling the to-be-measured time domain signal according to the to-be-measured sampling start point and the target sampling rate, and calculating a to-be-measured amplitude; a step S9, determining whether the to-be-measured time domain signal is lower than a size of the trigger amplitude, and if yes, proceeding to execute the step S1 or trigger an event; if no, proceeding to execute the step S6.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic diagram of a motor vibration or noise frequency detecting apparatus according to an embodiment of the disclosure.

FIG. 2 is a flowchart of a motor vibration or noise frequency detecting method according to an embodiment of the disclosure.

FIG. 3 is a schematic waveform diagram of a quantified time domain result.

FIG. 4 is a schematic waveform diagram of a frequency domain result computed form the quantified time domain result.

FIG. 5 is a schematic waveform diagram, in which a signal maximum value in starting N periods of the time domain signal is taken as a sampling start point, a sampling at double rate is performed according to a characteristic frequency, a characteristic amplitude is calculated, and a trigger amplitude is set according to the characteristic amplitude.

FIG. 6 is a schematic waveform diagram, in which a to-be-measured time domain signal is quantified, a signal maximum value in starting N periods of the time domain signal is taken as a sampling start point, and a sampling at double rate is performed according to the characteristic frequency by using the maximum value.

FIG. 7 is a schematic waveform diagram illustrating steps from quantifying the to-be-measured time domain signal to determining whether the to-be-measured amplitude is lower than a size of the trigger amplitude.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

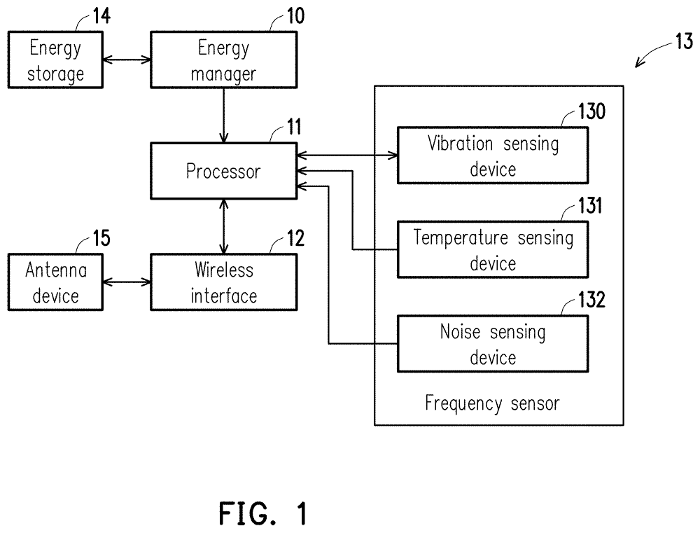

With reference to FIG. 1, the disclosure provides a motor vibration or noise frequency detecting apparatus that includes an energy manager 10, a processor 11, a wireless interface 12, a frequency sensor 13, an energy storage 14 and an antenna device 15.

The energy manager 10 is electrically connected to the processor 11. The processor 11 is electrically connected to the wireless interface 12. The energy storage 14 is electrically connected to the energy manager 10. The antenna device 15 is electrically connected to the wireless interface 12.

The frequency sensing unit 13 is installed in a motor apparatus. The frequency sensing unit 13 at least includes a vibration sensing device 130, a noise sensor 132, and can also additionally include a temperature sensing device 131.

The vibration sensing device 130, the temperature sensing device 131 and the noise sensor 132 are electrically connected to the processor 11. The energy storage 14 stores electrical energy, and provides electrical energy to the energy manager 10.

The frequency sensing unit 13 is applied in a motor apparatus. The processor 11 makes the vibration sensing device 130 or the noise sensor 132 samples a time domain signal through a set sampling rate and a set number of samples to obtain a quantified time domain result, converts an analog signal presenting the quantified time domain result into a digital signal by an analog-to-digital converter, then computes the digital signal into a frequency domain result through a Fourier transform method, takes a frequency with a largest intensity from the frequency domain result as a characteristic frequency, finds a signal maximum value in at least one starting period from the quantified time domain result, starting from the signal maximum value, sets a target sampling rate according to a range from more than twice the characteristic frequency to the set sampling rate, obtains a characteristic time domain result through the target sampling rate, and calculates a characteristic amplitude through the characteristic time domain result. The characteristic amplitude determines a size of a trigger amplitude for use in computations or triggering events.

The frequency domain result, the characteristic frequency, the target sampling rate, the characteristic time domain result and the characteristic amplitude obtained by the processor 11 are transmitted via the wireless interface 12 and the antenna device 15 and received by corresponding devices.

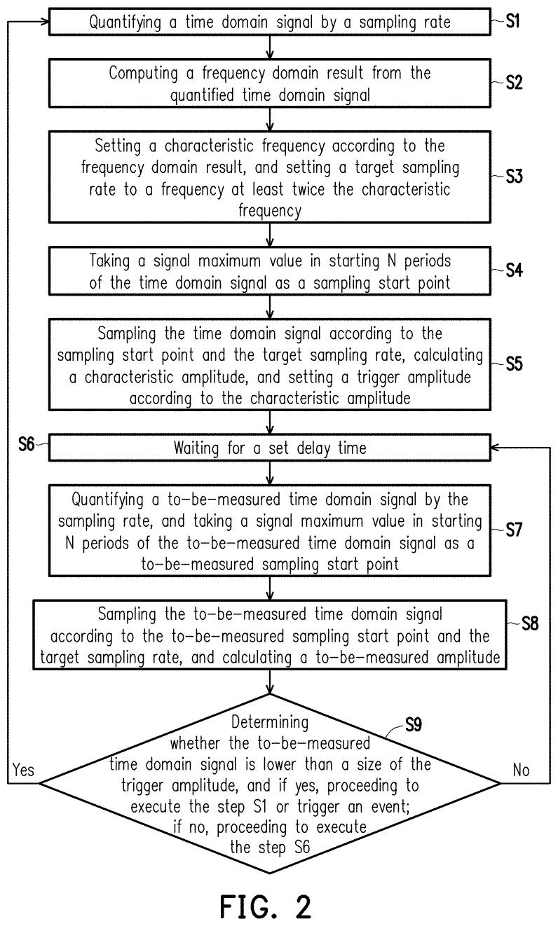

With reference to FIG. 2, the disclosure provides a motor vibration or noise frequency detecting method with steps therein described as follows.

In a step S1, a time domain signal is quantified by a sampling rate.

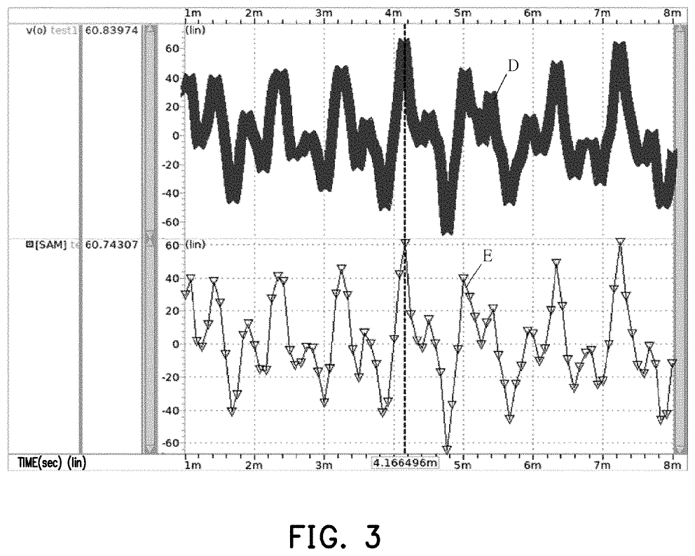

With reference to FIG. 3, FIG. 3 is schematic waveform diagram of a quantified time domain result. For instance, by sampling an original time domain signal D (upper portion of FIG. 3) at 12 kSPS (samples per second), a quantified time domain signal E at a 12 kSPS sampling rate is obtained (lower portion of FIG. 3).

In a step S2, a frequency domain result is computed from the quantified time domain signal. The processor 11 computes the quantified time domain result into a frequency domain result through a Fourier transform method.

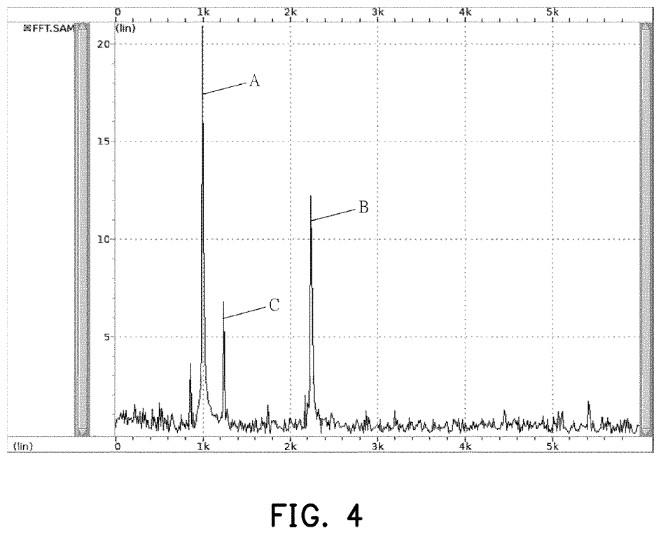

With reference to FIG. 4, FIG. 4 is a schematic waveform diagram of a frequency domain result computed form the quantified time domain result. The quantified time domain signal E sampled at the 12 kSPS sampling rate of FIG. 3 indicates the frequency domain result, an analog signal presenting the quantified time domain result is converted into a digital signal by the analog-to-digital converter, and then the digital signal is computed into the frequency domain result through a Fourier transform method.

In a step S3, a characteristic frequency is set according to the frequency domain result, and a target sampling rate is set to a frequency at least twice the characteristic frequency. With reference to FIG. 4, the processor 11 takes a frequency with a largest intensity from the frequency domain result as a characteristic frequency. The taken frequency with the largest intensity is set as a first characteristic frequency A, and the first characteristic frequency A is 1 kHz. Similarly, a second characteristic frequency B and a third characteristic frequency C refer to frequencies with a second largest intensity and a third largest intensity, respectively.

In a step S4, a signal maximum value in starting N periods of the time domain signal is taken as a sampling start point, where N is at least one period.

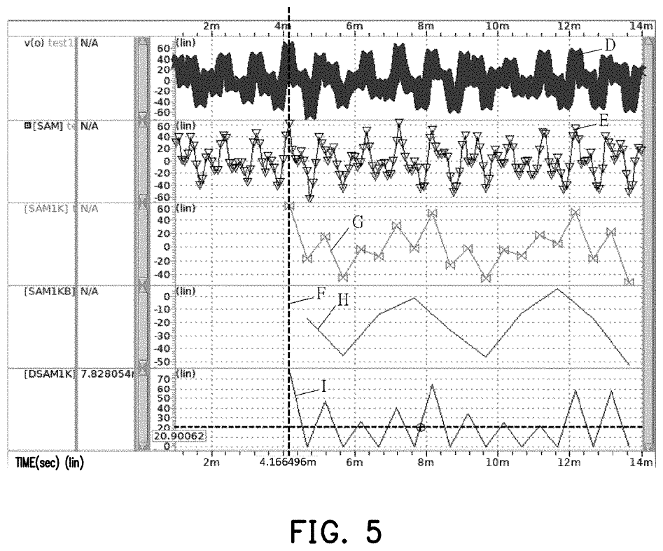

Further, with reference to FIG. 5, for instance, the signal maximum value in staring N periods of the quantified time domain signal E at the 12 kSPS sampling rate is taken as a sampling start point F.

In a step S5, the time domain signal is sampled according to the sampling start point and the target sampling rate, a characteristic amplitude is calculated, and a trigger amplitude is set according to the characteristic amplitude. The processor 11 sets, starting from a maximum peak value of the quantified time domain signal E, a target sampling rate according to more than twice the characteristic frequency (e.g., uses a double frequency 2 kHz of the characteristic frequency 1 kHz as the target sampling rate), obtains a characteristic time domain result through the target sampling rate, calculates a characteristic amplitude through the characteristic time domain result, and sets a trigger amplitude by the characteristic amplitude.

With reference to FIG. 5, FIG. 5 is a schematic waveform diagram, in which the signal maximum value in the starting N periods of the quantified time domain signal E is taken as the sampling start point F, a sampling at double rate is performed according to a characteristic frequency, a characteristic amplitude is calculated, and a trigger amplitude is set according to the characteristic amplitude. By a sampling waveform E at the 12 kSPS sampling rate of FIG. 3 is sampled at 2 kSPS, a sampling waveform G at a 2 kSPS sampling rate of FIG. 5 may be obtained. By taking the sampling waveform G at the 2 kSPS sampling rate by 180 degree in phase, a baseline H of a 2 kSPS sampling waveform may be obtained through computation with half the rate 1 kSPS. Further, by computing the sampling waveform G at the 2 kSPS sampling rate and the baseline H of the 2 kSPS sampling waveform into a superimposed waveform I, a characteristic amplitude is one referring to a maximum amplitude value of the superimposed waveform I in a period of time. Also, with reference to the characteristic amplitude, a value less than or equal to the characteristic amplitude is set as a trigger amplitude.

In a step S6, a set delay time is being waited. The processor 11 waits for a set delay time.

In a step S7, a to-be-measured time domain signal is quantified, and a signal maximum value in starting N periods of the to-be-measured time domain signal is taken as a to-be-measured sampling start point, where N is at least one period. The processor 11 samples a to-be-measured time domain signal by the sampling rate, and obtains a quantified to-be-measured time domain signal.

For instance, after a main oscillating frequency of the motor apparatus is changed from 1 kHz to 1.2 kHz or other non-1 kHz frequencies, its amplitude will also be changed accordingly after calculation so the to-be-measured time domain result obtained is inevitably different. If the original first characteristic frequency no longer exists, it means that the operating state has changed or the motor has an abnormal condition.

In a step S8, the to-be-measured time domain signal is sampled according to the to-be-measured sampling start point and the target sampling rate, and a to-be-measured amplitude is calculated. The processor 11 finds a maximum value in at least one starting period from the quantified time domain signal, and uses the maximum value as a to-be-measured sampling start point. Starting from the maximal value, the processor 11 sets a to-be-measured sampling rate according to a range from more than twice the characteristic frequency to the set sampling rate, obtains a to-be-measured time domain result through the to-be-measured sampling rate, and then calculates a to-be-measured amplitude through the to-be-measured time domain result. The to-be-measured amplitude is calculated in the same way as the characteristic amplitude described in the step S4 to the step S5.

In a step S9, whether the to-be-measured time domain signal is lower than a size of the trigger amplitude is determined, and if yes, the step S1 is executed or an event is triggered; if no, the step S6 is executed.

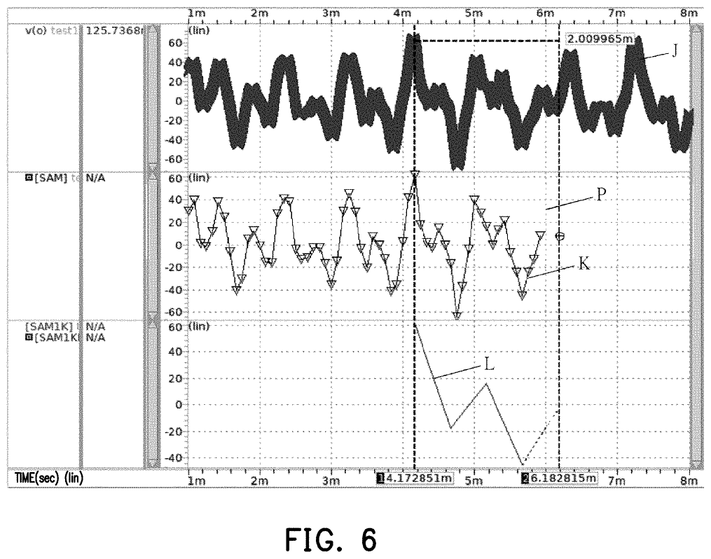

With reference to FIG. 6, an original to-be-measured time domain signal J is sampled at 12 kSPS, and the maximum value in N periods of a quantified time domain signal K is taken as a start point for a sampling at 2 kSPS, and the a value of N is at least one period. In a region P, before the sampling is completely switched to the 2 kSPS sampling rate, the 12 kSPS sampling rate will still be maintained until the sampling moves from a 12 kSPS sampling point to a next 2 kSPS sampling point. This operation can reduce the high frequency of 12 kSPS to the 2 kSPS sampling rate to achieve a power saving effect.

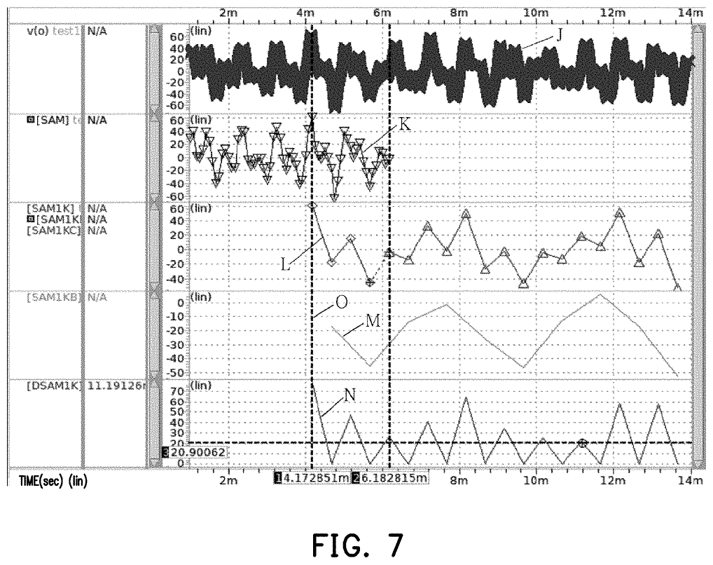

With reference to FIG. 7, FIG. 7 is a schematic waveform diagram illustrating steps from quantifying the to-be-measured time domain signal to determining whether the to-be-measured amplitude is lower than a size of the trigger amplitude. After sampling the original to-be-measured time domain signal J (a top portion of FIG. 7) at 12 kSPS, the quantified to-be-measured time domain signal K (a second portion of FIG. 7 counted from atop) may be obtained. With the signal maximum value in the starting N periods of the quantified to-be-measured the quantified time domain signal K taken as a sampling start point O, the quantified to-be-measured time domain signal K is sampled at the 2 kSPS sampling rate so a sample waveform L at 2 kSPS can be obtained. By taking the sampling waveform L at 2 kSPS by 180 degree in phase, a baseline M of the sampling waveform L at 2 kSPS may be obtained through computation. Further, the sampling waveform L at 2 kSPS and the baseline M are computed into a superimposed waveform N. A maximum amplitude of the superimposed waveform N is the to-be-measured amplitude. If the to-be-measured amplitude is less than the trigger amplitude, the step Si is executed or an event is triggered; If the to-be-measured amplitude is not less than the trigger amplitude, the step S6 is executed.

In summary, according to the motor vibration or noise frequency detecting apparatus and the method thereof, the processor 11 can compute a time domain signal, calculate a frequency domain result from the time domain signal, take a frequency with a largest intensity from the frequency domain result as a characteristic frequency, set a target sampling rate according to a sampling rate that is more than twice the characteristic frequency, and switch the set sampling rate to the target sampling rate to perform a sampling computation in a time domain signal sensing.

It will be apparent to those skilled in the art that various modifications and variations can be made to the disclosed embodiments. It is intended that the specification and examples be considered as exemplary only, with a true scope of the disclosure being indicated by the following claims and their equivalents.

1. A motor vibration or noise frequency detecting apparatus, comprising:
a processor; and
a frequency sensing unit, electrically connected to the processor, the frequency sensing unit at least having a vibration sensing device and a noise sensing device;
wherein the processor quantifies a time domain signal captured from the frequency sensing unit by a sampling rate (a step S1); computes a frequency domain result from the quantified time domain signal (a step S2); sets a characteristic frequency according to the frequency domain result, and sets a target sampling rate to a frequency at least twice the characteristic frequency (a step S3); takes a signal maximum value in starting N periods of the time domain signal as a sampling start point (a step S4), where N is at least one period; samples the time domain signal according to the sampling start point and the target sampling rate, calculates a characteristic amplitude, and sets a trigger amplitude according to the characteristic amplitude (a step S5); waits for a set delay time (a step S6); quantifies a to-be-measured time domain signal by the sampling rate, and takes a signal maximum value in starting N periods of the to-be-measured time domain signal as a to-be-measured sampling start point (a step S7), where N is at least one period; samples the to-be-measured time domain signal according to the to-be-measured sampling start point and the target sampling rate, and calculates a to-be-measured amplitude (a step S8); and determines whether the to-be-measured time domain signal is lower than a size of the trigger amplitude, and if yes, proceeds to execute the step Si or trigger an event; is no, proceeds to execute the step S6 (a step S9).

2. The motor vibration or noise frequency detecting apparatus according to claim 1, further comprising: an energy manager, the energy manager being electrically connected to the frequency sensing unit and the processor.

3. The motor vibration or noise frequency detecting apparatus according to claim 1, further comprising: an energy storage, the energy storage being electrically connected to the energy manager.

4. The motor vibration or noise frequency detecting apparatus according to claim 1, further comprising: a wireless interface and an antenna device, the wireless interface being electrically connected to the processor, the antenna device being electrically connected to the wireless interface.

5. A motor vibration or noise frequency detecting method, comprising:
a step S1, quantifying a time domain signal by a first sampling rate;
a step S2, computing a frequency domain result from the quantified time domain signal;
a step S3, setting a characteristic frequency according to the frequency domain result, and setting a target sampling rate to a frequency at least twice the characteristic frequency;
a step S4, taking a signal maximum value in starting N periods of the time domain signal as a sampling start point, where N is at least one period;
a step S5, sampling the time domain signal according to the sampling start point and the target sampling rate, calculating a characteristic amplitude, and setting a trigger amplitude according to the characteristic amplitude;
a step S6, waiting for a set delay time;
a step S7, quantifying a to-be-measured time domain signal, and taking a signal maximum value in starting N periods of the to-be-measured time domain signal as a to-be-measured sampling start point, where N is at least one period;
a step S8, sampling the to-be-measured time domain signal according to the to-be-measured sampling start point and the target sampling rate, and calculating a to-be-measured amplitude;
a step S9, determining whether the to-be-measured time domain signal is lower than a size of the trigger amplitude, and if yes, proceeding to execute the step Si or trigger an event; if no, proceeding to execute the step S6.

6. The motor vibration or noise frequency detecting method according to claim 5, wherein in the step S1, the time domain signal is sampled through a set sampling rate and a set number of samples, and a quantified time domain result is obtained.

7. The motor vibration or noise frequency detecting method according to claim 6, wherein in the step S2, an analog signal presenting the quantified time domain result is converted into a digital signal by an analog-to-digital converter, and then the digital signal is computed into the frequency domain result through a Fourier transform method.

8. The motor vibration or noise frequency detecting method according to claim 5, wherein in the step S3, a frequency with a largest intensity from the frequency domain result is taken as the characteristic frequency.

9. The motor vibration or noise frequency detecting method according to claim 6, wherein in the step S4, a maximum value in at least one starting period is found from the quantified time domain result, and the maximum value is taken as the sampling start point.

10. The motor vibration or noise frequency detecting method according to claim 5, wherein the step S5 further comprises:
with the sampling start point as a start point, sampling the time domain signal by the target sampling rate to obtain a sampling waveform;
taking the sampling waveform by 180 degree in phase to be sampled by a second sampling rate to obtain a first baseline;
computing the sampling waveform and the first baseline into a first superimposed waveform, wherein a maximum amplitude value the first superimposed waveform is the characteristic amplitude; and
setting a value less than or equal the characteristic amplitude as the trigger amplitude.

11. The motor vibration or noise frequency detecting method according to claim 5, wherein in the step S7, the to-be-measured time domain signal is sampled by the first sampling rate, and a quantified to-be-measured time domain signal is obtained.

12. The motor vibration or noise frequency detecting method according to claim 5, wherein the step S8 further comprises:
with the to-be-measured start point as the sampling start point, sampling a quantified to-be-measured time domain signal by the target sampling rate to obtain a to-be-measured sampling waveform;
taking the to-be-measured sampling waveform by 180 degree in phase to be sampled by a second sampling rate to obtain a second baseline; and
computing the to-be-measured sampling waveform and the second baseline into a second superimposed waveform, wherein a maximum amplitude value the second superimposed waveform is the to-be-measured amplitude.
